(19) United States
(12) Patent Application Publication
(10) Pub. No.: US 2009/0287411 A1
(43) Pub. Date: Nov. 19, 2009

(54) System and Method for Managing Messages in a Network Data Processing System Using a Check-In Policy

(75) Inventors: Jeffrey Michael Sweeney, Olathe, KS (US); Kelsyn Donel Rooks, SR., Overland Park, KS (US); Michael Clayton Robinson, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/122,893

(22) Filed: May 19, 2008

(51) Int. Cl. G06F 15/16; G01C 21/00

(52) U.S. Cl. 701/213; 709/206

(57) ABSTRACT

The illustrative embodiments described herein provide a method, apparatus, and computer program product for managing messages in a network data processing system. In one illustrative embodiment, the process receives input associated with a set of check-in policy settings for a user of a first communication device. The process generates a check-in policy using the set of check-in policy settings. The process initiates a prompt on the first communication device to perform an action on the first communication device in response to the check-in policy. The process also determines whether the action is performed by the user. The process sends a notification to a second communication device.

### BACKGROUND OF THE INVENTION

1. Field of the Invention

The present invention relates generally to a system and method for managing messages in a network data processing system. More particularly, the present invention relates to a system and method for managing messages in a network data processing system using a check-in policy.

2. Description of the Related Art

A person sometimes may desire information concerning the well-being of another person, especially in circumstances in which two people are at separate locations. For example, a parent or guardian may worry or be concerned about the safety of children for which they are responsible when those children are at a separate location than the parent or guardian. In this example, the child may be attending an educational or social function at which the parent or guardian is not present. In these and other types of situations, the parent or guardian may desire that the child “check-in” while the child is at the separate location as the parent or guardian. “Checking-in” includes any communication sent from one person to another that indicates the existence of the person checking in.

A person may check-in with another person in a number of different ways. For example, a person may manually check-in with another person, such as by physically traveling to the location of another person. In the example in which a child is the person checking-in, the child may physically travel to the location of the child's parent or guardian such that the parent of guardian is made aware of the child's existence or safety. However, manually checking-in in this manner causes substantially inconvenience to the parties involved in the check-in process. For example, the person checking-in is forced to interrupt his or her activity from which he or she is checking-in. In addition, the person checking-in interrupts the activity of the person to whom they are checking-in, such as the parent or guardian. Such manual checking-in process may also fail when, for example, the location of an enforcer of the check-in process, such as a parent or guardian, changes without the knowledge of the person checking-in. Manually checking-in may also require large amounts of time and labor to physically move to the check-in location.

The process of checking-in may also be facilitated by the use of communication devices. One current method by which a person may check-in with another person requires the person checking-in to call the person to whom they are checking-in. However, this method fails to provide the person checking-in with any reminder to check-in, such as a reminder to check-in at a particular time period. The need to call an enforcer of the check-in process also inconveniences both the person checking-in and an enforcer of the check-in process because each of these parties must either place or answer the call in order for the check-in process to succeed. This inconvenience is greatly increased when the check-in process includes multiple parties that are checking-in with a single enforcer, such as when several children are checking-in with a single parent or guardian. In this case, the parent or guardian may be subjected to multiple phone calls from each of the children, causing multiple interruptions to the parent or guardian's current activity. The enforcer of the check-in process may also have no way to customize the check-in process, such as by customizing the check-in process based on the time of day or location and age of the child. The inability of the enforcer to customize the check-in process using this method may be particularly problematic when contact cannot be made with the party checking-in and the enforcer of the check-in process desires to change the check-in process in some way, such as the check-in times.

### BRIEF SUMMARY OF THE INVENTION

The illustrative embodiments described herein are directed to a data processing system and, in particular, to a system and method for managing messages in a network data processing system. The process receives input associated with a set of check-in policy settings for a user of a first communication device. The process generates a check-in policy using the set of check-in policy settings. The process initiates a prompt on the first communication device to perform an action on the first communication device in response to the check-in policy. The process also determines whether the action is performed by the user. The process sends a notification to a second communication device.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a network data processing system in which the illustrative embodiments of the present invention may be implemented;

FIG. 2 is a block diagram of a data processing system in which the illustrative embodiments of the present invention may be implemented;

FIG. 3 is a block diagram of a user check-in system for managing messages in a network data processing system in accordance with an illustrative embodiment;

FIG. 4 is a flowchart illustrating a process for managing messages in a network data processing system in accordance with an illustrative embodiment;

FIG. 5 is a flowchart illustrating a process for managing messages in a network data processing system in accordance with an illustrative embodiment; and

FIG. 6 is a flowchart illustrating a process for managing messages in a network data processing system in accordance with an illustrative embodiment.

### DETAILED DESCRIPTION OF THE INVENTION

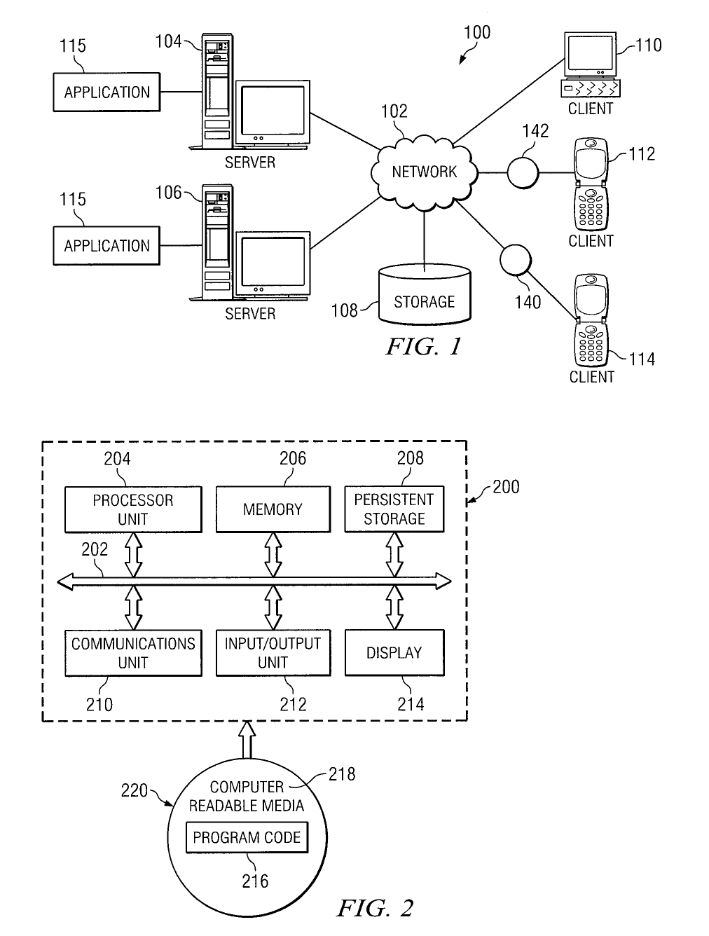

With reference now to the figures and in particular with reference to FIGS. 1 and 2, diagrams of data processing environments are provided in which illustrative embodiments may be implemented. It should be appreciated that FIGS. 1 and 2 are only examples and are not intended to assert or imply any limitation with regard to the environments in which different embodiments may be implemented. Many modifications to the depicted environments may be made.

FIG. 1 depicts a pictorial representation of a network of data processing systems 100 in which illustrative embodiments may be implemented. Network data processing system 100 is a network of computers in which the illustrative embodiments may be implemented. Network data processing system 100 contains a network 102, which is the medium used to provide communication links between various devices and computers connected together within network data processing system 100. Network 102 may include connections, such as wire, wireless communication links, or fiber optic cables. In one example, network 102 is an Over the Air network that may be used by phone service providers to transmit data.

In the depicted example, a server 104 and a server 106 connect to network 102 along with a storage unit 108. In addition, clients 110, 112, and 114 connect to network 102. Clients 110, 112, and 114 may be any communication devices. Communication devices are commonly used in a wide variety of commercial, governmental, and personal applications. A communication device is any device capable of communicating with a user or another device. Non-limiting examples of communication devices include phones, which include landline and cellular phones, walkie talkies, personal computers, personal digital assistants, music players, and laptop computers. Communication devices allow a user to execute a wide variety of applications, including executing voice calls, text messaging, internet browsing, music playback, memo recording, personal organization functions, e-mail, instant messaging, camera and camcorder applications, radio reception, video games, and modem functions for other devices. In the example of FIG. 1, clients 112 and 114 are cellular phones.

In this example, network 102 may provide a wireless communications network that allows clients 110, 112, and 114 to communicate with one another. The wireless communications network, including servers 104 and 106, may be managed by a service provider. In the depicted example, server 104 may provide data, such as boot files and applications to clients 110, 112, and 1 14. In one example, servers 104 may deploy or provide an application to clients 110, 112, and 114 for managing messages in network data processing system 100 using a check-in policy. In another example, an application 115 for managing messages in network data processing system 100 using a check-in policy may also be located at servers 104 and 106. In this example, a user of clients 110, 112, or 114 may input check-in preferences that are sent to servers 104 and 106 to form a set of check-in policy settings for the check-in policy used by application 115 on servers 104 and 106. The set of check-in policy settings includes one or more check-in policy settings. The check-in preferences may be sent by a user of clients 110, 112, or 114 over network 102 using a web portal in which the user may input the check-in preferences.

In one embodiment, application 115 may initiate a prompt 140 to be sent to any of clients 110, 112, or 114. In the example of FIG. 1, prompt 140 is sent to client 114. Prompt 140 may be a prompt to perform an action on client 114 in response to or in accordance with the check-in policy used by application 11 5. Application 115 may determine whether the action is performed by a user of client 114. Application 115 may also send a notification 142 to any of clients 110 or 112. The nature of the notification 142, including whether and when the notification 142 is sent, may depend on the check-in policy settings of the check-in policy in application 115. For example, notification 142 may be sent depending on whether the user of client 114 performs the action signaled by the prompt 140. Notification 142 may also be sent upon the initiation of prompt 140 to notify a user of any of clients 110 or 112 that prompt 140 has been initiated at client 114. Thus, the data that the notification 142 communicates to a user of any of clients 110 or 112 may vary depending on the type of event that notification 142 is programmed to convey.

Clients 110, 112, and 114 are clients to servers 104 and 106 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments. For example, network data processing system 100 may be implemented as any network that may be used to facilitate communication between communication devices, including a CDMA network such as cdmaOne or CDMA2000.

With reference now to FIG. 2, a block diagram of a data processing system 200 is shown in which illustrative embodiments may be implemented. Data processing system 200 is an example of a communication device or computer, such as servers 104 or 106 or clients 110, 112, and 114 in FIG. 1, in which computer-usable program code or instructions implementing the processes may be located for the illustrative embodiments. In one non-limiting example, data processing system 200 may be a cellular phone. Data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Memory 206 may store the assigned value of a variable. For example, memory 206 may contain the value given to a variable in a variable assignment. These values may also be contained in registers that are included in memory 206.

Communications unit 210, in these examples, provides for communications with other data processing systems or communication devices. In these examples, communications unit 210 is a network interface card. Communications unit 210 may provide communications through the use of either or both physical and wireless communication links.

Input/output unit 212 allows for the input and output of data with other devices that may be connected to data processing system 200. For example, input/output unit 212 may provide a connection for user input through a keyboard and mouse. Further, input/output unit 212 may send output to a printer. In the case in which data processing system 200 is a cellular phone, input/output unit 212 may also allow devices to be connected to the cellular phone, such as microphones, headsets, and controllers. Display 214 provides a mechanism to display information to a user. In the case in which data processing system 200 is a cellular phone, display 214 may be a graphical user interface on the cellular phone. In one non-limiting example, the display 214 may be used to display a prompt or a notification on the cell phone, such as prompt 140 or notification 142 in FIG. 1.

Instructions for the operating system and applications or programs are located on persistent storage 208. These instructions may be loaded into memory 206 for execution by processor unit 204. The processes of the different embodiments may be performed by processor unit 204 using computer-implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 and may be loaded onto or transferred to data processing system 200 for execution by processor unit 204. Program code 216 and computer-readable media 218 form computer program product 220 in these examples. In one embodiment, computer program product 220 is a computer program product for managing messages in a network data processing system using a check-in policy in accordance with an illustrative embodiment. For example, computer program product 220 may be a non-limiting example of application 115 in FIG. 1, or an application deployed to any one of clients 110, 112, or 114 in FIG. 1 that facilitates the management of messages in a data processing system using a check-in policy in accordance with the illustrative embodiments. Additional details regarding program code 216 on computer program product 220 are described in the figures below.

In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 may also take the form of a persistent storage, such as a hard drive or a flash memory that is connected to data processing system 200. The tangible form of computer-readable media 218 is also referred to as computer recordable storage media.

Alternatively, program code 216 may be transferred to data processing system 200 from computer-readable media 218 through a communication link to communications unit 210 and/or through a connection to input/output unit 212. The communication link and/or the connection may be physical or wireless in the illustrative examples. The computer-readable media also may take the form of non-tangible media, such as communication links or wireless transmissions containing the program code. In the example in which data processing system 200 is a cellular phone, program code 216 may be deployed to the cellular phone via over the air programming, the Internet, or Bluetooth, either of which may use network 102.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments described herein provide a computer-implemented method, apparatus, and computer program product for managing messages in a network data processing system. The process receives input associated with a set of check-in policy settings for a user of a first communication device. The process generates a check-in policy using the set of check-in policy settings. The process initiates a prompt on the first communication device to perform an action on the first communication device in response to the check-in policy. The process also determines whether the action is performed by the user. The process sends a notification to a second communication device.

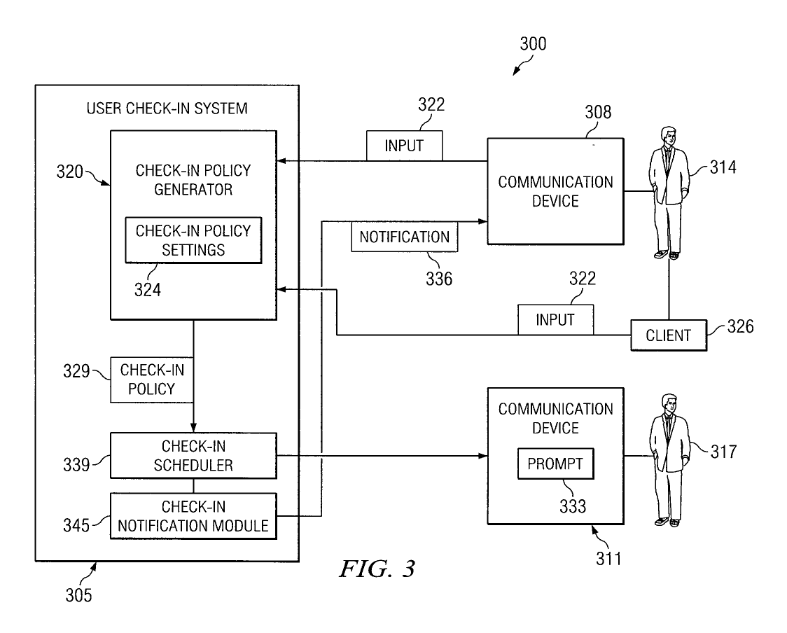

Turning now to FIG. 3, a block diagram of a user check-in system for managing messages in a network data processing system is shown in accordance with an illustrative embodiment. Specifically, FIG. 3 shows a data processing system 300 that includes a user check-in system 305. Data processing system 300 is a non-limiting example of network data processing system 100 in FIG. 1. In one example, user check-in system 305 is located on a server, such as servers 104 and/or 106 in FIG. 1. Data processing system 300 also includes communication devices 308 and 311, which are associated with users 314 and 317, respectively. In one non-limiting example, communication device 308 and 311 are each cellular phones. Communication device 308 and 311 may also be non-limiting examples of clients 112 and 114 in FIG. 1, respectively. User check-in system 305 generates, administers, and otherwise implements a check-in policy such that user 317 may check-in with user 314 using communication devices 311 and 308, respectively.

Although FIG. 3 shows a single user 317 that may check-in with another user, such as user 314, using user check-in system 305, any number of users may check-in with another user using user check-in system 305. Also, although FIG. 3 shows a single user 314 to whom user 317 checks-in using user check-in system 305, data processing system 300 may include any number of users to whom user 317 checks-in. In one example, user 314 is an enforcer, administrator, or creator of the check-in process implemented by user check-in system 305. User 314 may be a parent or guardian of user 317. In this example, any number of parents or guardians may enforce, administer, or create the check-in process implemented by user check-in system 305, and any number of children may use user check-in system 305 to check-in with their one or more parents or guardians.

User check-in system 305 may be used to manage messages or other communicated data in a network data processing system, such as network data processing system 100 in FIG. 1. In particular, user check-in system 305 may use a check-in policy to manage messages or other communicated data in a network data processing system. A check-in policy is one or more rules, settings, guidelines, and/or principles that govern a check-in process implemented by a user check-in system, such as user check-in system 305. In one example, user 317 may check-in with user 314 using one or more messages or other data that is sent between communication device 308, user check-in system 308, and communication device 31 1. The one or more messages or other data may be transmitted according to the user check-in policy generated by the user check-in system 305.

User check-in system 305 includes a check-in policy generator 320, a check-in scheduler 339, and a check-in notification module 345. In one embodiment, check-in policy generator 320, check-in scheduler 339, and check-in notification module 345 are software modules stored in a memory and executed by a processor. For example, check-in policy generator 320, check-in scheduler 339, and check-in notification module 345 may be stored in memory 206 of FIG. 2 and executed by processor unit 204 in FIG. 2. Alternatively, check-in policy generator 320, check-in scheduler 339, and check-in notification module 345 may be firmware or middleware that is located and/or executed on any of the servers or clients of network data processing system 100 in FIG. 1. Check-in policy generator 320, check-in scheduler 339, and check-in notification module 345 may also be firmware or middleware that is located and/or executed on data processing system 200 in FIG. 2.

In one embodiment, check-in policy generator 320 may receive input 322 associated with check-in preferences for user 317 of communication device 311 to form a set of check-in policy settings 324. In one example, input 322 may be sent from user 314 using communication device 308, such as a cellular phone. In another example, input 322 may be sent from user 314 using a client 326, which is a non-limiting example of any of clients 110, 112, or 114 in FIG. 1. In either of these examples, user 315 may enter input 322 via communication device 308 or client 326 using a website. The website may be an interface implemented by user check-in system 305 through which user 314 may send input 322 over a network, such as network 102 in FIG. 1. The website may be an access-controlled website that allows only authorized users to enter input that is communicated to user check-in system 305 to form check-in policy settings 324.

A check-in policy setting in check-in policy settings 324 may be any parameter, selectable option, or other data that is used to form check-in policy 329, which is generated by check-in policy generator 320. Check-in policy settings 324 govern check-in policy 329, and may be used by user 314 or any other user to customize the check-in policy according to characteristics of any of the users utilizing user check-in system 305 or user preferences. In another example, some of the settings in check-in policy settings 324 may affect other settings in check-in policy settings 324. The manner in which such settings affects other settings in check-in policy settings 324 may be defined by check-in policy generator 320, or may be defined by a user, such as user 314.

Non-limiting examples of check-in policy settings that may be included in check-in policy settings 324 are a check-in time period, a check-in frequency, a check-in time, a game mode, a user-phone association, a number of children, a user age, a user level of maturity, a check-in alert type, a prompt type, a notification alert type, a notification mode, including but not limited to an exception notification mode and a real-time notification mode, and a permission level for the check-in policy.

The check-in time period setting is the time period during which user 317 checks-in with user 314 using user check-in system 305. For example, the check-in time period may be a time period in which user 314 desires user 317 to check-in with user 314. In one example, user check-in system 305 implements check-in policy 329 during the check-in time period. User 317 may check-in with user 314 any number of times during the check-in time period. The check-in frequency setting is the frequency at which user 317 checks-in with user 314 using user check-in system 305. For example, the check-in frequency may indicate that user 317 must check-in every 5 minutes, every 30 minutes, every hour, every two hours, irregular time intervals, or any other time interval. In one non-limiting example, the check-in frequency is the frequency at which user 317 checks-in with user 314 during the check-in time period setting discussed above. The check-in time setting is one or more times at which user 317 checks-in with user 314 using user check-in system 305. For example, the check-time settings may indicate that user 317 must check-in at 8:00 P.M., midnight, or any other time.

The game mode setting indicates whether user check-in system 305 utilizes a game on communication device 311 to facilitate the check-in process. Additional details regarding the use of a game to facilitate the check-in process implemented by user check-in system 305 are provided below. The user-phone association settings indicates the user that is using a particular communication device that communicates with user check-in system 305. For example, the user-phone association setting may indicate that user 317 is associated with communication device 311. Using this setting, any user may be associated with communication device 311. Thus, even if user 317 is the primary user of communication device 311, any user may be associated with communication device 311 such that they are able to use communication device 311 to check-in with user 314 using user check-in system 305.

The number of children setting indicates the number of children that are checking-in with user 314 using user check-in system 305. In the situation in which user 314 is a parent or guardian of user 317, the number of children setting may be set to one. However, any number of children having communication devices may check-in with user 314 using user check-in system 305. The number of children may be indicated by the number of children setting. In another embodiment in which user 314 is not a parent or guardian of user 317, the number of children setting may instead be a number of checking-in users setting. In this embodiment, the number of checking-in users setting indicates the number of users using user check-in system 305 to check-in with user 314 or any other additional enforcing or administrating users.

The user age setting indicates the age of any users, such as user 317, checking-in with user 314 using user check-in system 305. The user level of maturity setting indicates the level of maturity of any users, such as user 317, checking-in with user 314 using user check-in system 305. The level of maturity may be indicated in variety of different ways. For example, the level of maturity may be indicated on a scale of I to 10. In another example, user 314 may classify user 317 as very mature, moderately mature, or immature. Both the user age setting and the level of maturity setting may affect other settings in the check-in policy settings 324. For example, either or both of user age setting and the level of maturity setting may affect the check-in frequency setting or the check-in time setting. In this example, a high age or high level of maturity may decrease the frequency at which a user must check-in with user 314. The manner in which the user age setting or user level of maturity setting affects other settings in check-in policy settings 324, such as the check-in frequency setting or the check-in time setting, may be defined by check-in policy generator 320 or may be defined by a user.

The prompt type setting is the type and content of a prompt 333 presented to user 317. The prompt 333 prompts user 317 to perform an action on communication device 311 in response to or in accordance with check-in policy 329. The action prompted by prompt 333 may also be indicated by the prompt type setting. The check-in alert type setting indicates an alert type when prompt 333 is initiated on communication device 311. Additional details regarding the prompt type settings and the check-in alert type setting are provided below.

The notification mode setting indicates the type and content of a notification 336 that is sent to communication device 308. For example, the notification mode setting may indicate an event the triggers the transmission of notification 336 to communication device 308. For example, the notification mode setting may be set to an exception notification mode in which an enforcer, such as user 314, is notified only if user 317 does not comply with one or more rules or settings in check-in policy 329. By way of a specific non-limiting example, when the notification mode is set to the exception notification mode, user 314 may receive notification 336 if user 317 fails to perform a required action on communication device 311 during a predetermined time. In another example, the notification mode setting may be set to a real-time notification mode in which the enforcer, such as user 314, is notified each time a check-in gate or prompt, such as prompt 333, is initiated on communication device 311. These notification modes, as well as others described in the illustrative embodiments, may be selected depending on a variety of factors, such as the relationship between user 314 and user 317 (e.g., parent and child relationship), the number of users, the age or maturity level of the users, the level of proficiency that each of the users has with user check-in system 305, or any other factors.

The notification alert type setting indicates an alert type when notification 336 is sent to communication device 308. Additional details regarding the notification mode setting and the notification alert type setting are provided below.

The permission level setting indicates the level of authority assigned to a particular user to set or change check-in policy settings 324. For example, the permission level setting may indicate that user 314 has full access to set or change check-in policy settings 324. In another example, the permission level setting may indicate that user 317 or any other users checking-in with user 314 have little or no ability to set or change check-in policy settings 324. In the example in which user 314 is a parent or guardian of user 317, the permission level setting may indicate that only the parent or guardian has the ability to set or change check-in policy settings.

Check-in policy generator 320 generates check-in policy 329 using check-in policy settings 324. Any portion or combination of the aforementioned settings, as well as additional settings not given as examples, may be used to generate check-in policy 329. Specific non-limiting examples of check-in policies that are generated using the aforementioned settings will be provided below.

User check-in system 305 includes check-in scheduler 339. In one embodiment, check-in scheduler 339 initiates prompt 333 on communication device 311 to perform an action on communication device 311 in response to or in accordance with check-in policy 329. Prompt 333 may be a means by which user 317 is able to check-in with user 314 using communication device 311. Although check-in scheduler 339 is shown to initiate prompt 333 on a single communication device 311, check-in scheduler 339 may initiate prompts on any number of communication devices for any number of users in response to or in accordance with check-in policy 329.

The action to be performed by user 317 that is prompted by prompt 333 may be any type of action. For example, prompt 333 may prompt user 317 to perform the action of clicking a button on a graphical user interface of communication device 311. In this example, the button may be an “okay” or “check-in” button that is selected by user 317. In another example, prompt 333 may prompt user 317 to perform the action of inputting a code, password, or other series of characters into communication device 311. In another example, prompt 333 may prompt user 317 to perform the action of pressing a button on communication device 311, such as a button on the keypad of communication device 311. In another example, prompt 333 may prompt user 317 to perform the action of launching a website using an internet browser on communication device 333. User 317 may perform one or more additional actions using the launched website to complete a check-in process. Prompt 333 may also be a text message that prompts user 317 to perform an action. These and other actions to be performed by user 317 in response to prompt 333 may be indicated by the prompt type setting in the check-in policy settings 324.

In one embodiment, the initiation of the prompt 333 by the check-in scheduler 339 may initiate an alert on the communication device 311. The alert may notify user 317 that prompt 333 has been initiated on communication device 311. For example, the alert may be a display on a graphical user interface of communication device 311. In another example, the alert is a sound, such as a ringer, beep, or other noise. The alert may also be a vibration of communication device 311. In another example, the alert may be a light emitted from communication device 311, such as the illumination of an LED on communication device 311. These and other alerts may be indicated by the check-in alert type setting in check-in policy settings 324.

User check-in system 305 also includes check-in notification module 345. In one embodiment, check-in notification module 345 sends notification 336 to communication device 308. For example, check-in notification module 345 may send notification 336 to communication device 308 in response to initiating prompt 333 on communication device 311. In this example, notification 336 may indicate that prompt 333 has been initiated on communication device 311. Thus, user 314, which may be a parent or guardian of user 317, may be alerted of the current status of user check-in system 305, and be assured that user check-in system 305 is functioning properly and in accordance with check-in policy settings 324 governed at least in part by input 322.

In another embodiment, check-in notification module 345 determines whether the action, which may be prompted by prompt 333 as described above, has been performed by user 317. In one example of this embodiment, check-in notification module 345 may determine that the action has been performed by user 317. In this example, check-in notification module 345 may send notification 336 to communication device 308 in response to determining that the action has been performed by user 317. Notification 336 in this example may indicate that the action has been performed by user 317. As a result, user 314, which may be a parent or guardian of user 317, may be assured of the well-being of user 317.

In another example of this embodiment, check-in notification module 345 may determine that the action has not been performed by user 317. Check-in notification module 345 may also determine that the action has not been performed by user 317 within a predetermined time period. The predetermined time period may be indicated by a setting in check-in policy settings 324, and may be indicated by input 322 from user 314. Check-in notification module 345 may send notification 336 to communication device 308 in response to determining that the action has not been performed by user 317. Check-in notification module 345 may also send notification 336 to communication device 308 in response to determining that the action has not been performed by user 317 within the predetermined time period. Notification 336 in this example may indicate that the action was not performed by user 317, or was not performed by user 317 within the predetermined time period. Thus, user 314, which may be a parent or guardian of user 317, may be alerted of the failure of user 317 to check-in. The parent or guardian may then take precautionary measures, or any other measures, to ensure the well-being of user 317.

In another example of this embodiment, check-in notification module 345 may determine whether a plurality of actions has been performed by user 317. The type and number of actions in the plurality of actions may be indicated by check-in policy settings 324, and be governed at least in part by input 322 from user 314. In one example, check-in notification module 345 may determine that the plurality of actions has not been performed by user 317. Check-in notification module 345 may send notification 336 to communication device 308 in response to determining that the plurality of actions has not been performed by user 317. Notification 336 in this example may indicate that the plurality of actions has not been performed by user 317.

In one non-limiting example, notification 336 may be in the form of a text message. In another example, the sending of notification 336 to communication device 308 by check-in notification module 345 may initiate an alert on communication device 308. The alert may notify user 314 that notification 336 has been sent to communication device 308. For example, the alert may be a display on a graphical user interface of communication device 308. In another example, the alert is a sound, such as a ringer, beep, or other noise. The alert may also be a vibration of communication device 308. In another example, the alert may be a light emitted from communication device 308, such as the illumination of an LED on communication device 308. These and other alerts may be indicated by the notification alert type setting in check-in policy settings 324.

In another embodiment, user check-in system 305 may initiate a game on communication device 311. In this example, the game may have a goal. Non-limiting examples of games that have a goal are puzzle games, race games, and other games that have an objective. In this embodiment, the game initiated by user check-in system 305 may advance toward the goal in response to determining that an action, which may be prompted by prompt 333 as described above, has been performed by user 317. Alternatively, the game may regress away from the goal in response to determining that the action has not been performed by user 317.

The inclusion of the game on communication device 311 facilitates making the check-in experience fun and reinforce responsible behavior by visually and audibly depicting each successful action or check-in as a positive movement towards a goal, such as advancing a bar across a screen, completing a piece of a puzzle, or completing a musical jingle. As an example, if a parent or guardian established four check-ins for the evening, the child may see one piece of the puzzle fill in for each successful action or check-in in response to prompt 333. In another type of game, the child may see a bar advance across a screen for each of the four actions or check-ins.

Using the illustrative embodiments, a parent or guardian, which may be user 314, can configure user check-in system 305 to require a child, which may be user 317, to conduct an action on communication device 311, such as enter a short code, respond to a link, or click on an okay button during predetermined times and/or duration of times and/or frequency intervals established by the parent or guardian. User check-in system 305 may be configured so that the parent or guardian receives an indication in the form of a text message, alert, or other update upon successful completion of the check-in process during the predetermined time. This text message, alert, or other update may be non-limiting examples of notification 336. User check-in system 305 may also be configured so that the parent or guardian receives notification 336 only if the child misses a check-in or a series of check-ins. Depending on the child's age, the child's level of maturity, the social situation (e.g., sleep over, date, party, etc. . . . ), and other parameters, the parent or guardian may elect to set up rules resulting in the need for a child to check-in every hour, check-in during a five or ten minute window during a given hour, simply check-in once during the evening, or any other rules/parameters deemed appropriate by the parent or guardian for their child, the particular social situation, or other considerations. Alerts may be configured as part of the features/functionality of user check-in system 305 as reminders for one or more children to respond to the check-in process and/or for the parent or guardian to be made aware of a pending or missed check-in deadline in accordance with the illustrative embodiments.

Non-limiting examples are now given to further describe the management of messages in data processing system 300 using check-in policy 329 in accordance with the illustrative embodiments. In a first non-limiting example, several settings in check-in policy settings 324 are indicated by input 322 from user 314 to form check-in policy 329. In this example, the check-in time period setting indicates a time period of 6:00 P.M. to 9:00 P.M., and the check-in frequency setting indicates a check-in frequency of one hour. The check-in alert type setting is set to cause a beep to emit from communication device 311 when prompt 333 is initiated at communication device 311. The notification mode setting is set to send notification 336 to communication device 308 if user 317 fails to respond to prompt 333 within five minutes. Check-in policy generator may generate check-in policy 329 using these example settings. The check-in scheduler 339 administers this check-in policy 329 by initiating prompt 333 at communication device 311 at one hour intervals between 6:00 P.M to 9:00 P.M.. Each time prompt 333 is initiated at communication device 311, a beep is emitted from communication device 311. If user 317 fails to respond to any one of these hourly prompts within five minutes, notification 336 is sent to communication device 308.

In a second non-limiting example, the user age setting indicates that user 317 is twelve years old. The game mode setting may be set to a puzzle setting. A social situation setting may be set to a sleep over. The check-in policy generator may generate check-in policy 329 using these example settings. The check-in scheduler 339 administers this check-in policy 329 by initiating prompt 333 at communication device 311 at two hour intervals until 11:00 P.M.. Each time user 317 successfully responds to prompt 333, a piece of a puzzle may be inserted into a game puzzle on the graphical user interface of communication device 311 such that the puzzle is brought nearer to completion upon each successful check-in.

Using the illustrative embodiments, multiple users may be loaded to or otherwise in communication with user check-in system 305. Each of these users may have corresponding check-in rules or settings. For example, user check-in system 305 may manage rules, settings, and compliance for multiple users and send outbound communications to multiple enforcers of one or more check-in policies using multiple methods, such as short message service (SMS), e-mail, recorded message to a landline, or any other alert or notification described in the illustrative embodiments. For example, one or more designated enforcers may be notified using a notification, such as notification 336. In this example, the notification may be sent upon successful completion or failure to complete a check-in, including a successful or non-successful response to a prompt such as prompt 333, depending upon on the rules or settings for the group of multiple users or for each individual user.

In one example, the illustrative embodiment may be used by a fraternity or sorority house that wants to ensure the safety of their members. In this example, two people, here referred to as Person A and Person B, may be designated responsible parties or enforcers of a check-in policy. Each member of the fraternity or sorority may be required to check-in via user check-in system 305 before midnight. In one example scenario, Person C, who is a member of the fraternity or sorority, fails to check-in at the designated time. In this case, an SMS alert message may be sent to Person A's cellular phone. An e-mail message may be sent to Person B. On a different night, two new people may be designated as the responsible parties or enforcers of the check-in policy, and a 1:00 am curfew may be imposed.

In another example of the illustrative embodiments, a trucking company may load the delivery routes and expected delivery times for several truckers into user check-in system 305. In this example, if a trucker fails to check-in during a predetermined time frame, user check-in system 305 may send an office manager a text message and/or e-mail.

In another example of the illustrative embodiments, a company, such as a temp agency, may use user check-in system 305 as a “time clock” for workers to indicate either or both of their arrival or departure at a work site. This time clock may be used in conjunction with a global positioning system to ensure the accuracy of data acquired using user check-in system 305 in this example. In this example, the temp agency may be spared from fielding large numbers of calls during the work day as each worker calls to check-in.

In another embodiment, check-in policy settings 324 may indicate a first location of user 317. This location may be indicated by input 322 from user 314. In this embodiment, user check-in system 305 may determine a second location of user 317 using a global positioning system, or “GPS.” This second location may be determined by locating communication device 311 by using a GPS. In this embodiment, user check-in system 305 may compare the first location to the second location. User check-in system 305 may send notification 336 to communication device 308 when the first location is different from the second location. In this example, notification 336 may indicate that the first location is different from the second location. Thus, user 314 may take any necessary precautions or other measures to ensure the well-being of user 317.

In one example, each of the functions of communication devices 308 and 311 as described in the illustrative embodiments may be implemented using only text messaging functionality on communication devices 308 and 311. Each of the functions of communication devices 308 and 311 as described in the illustrative embodiments may be implemented by a deployable application located in communication devices 308 and 311. In this example, user check-in system 305 may deploy computer readable code for either or both of the communication devices 308 and 311 that facilitates the functionality of user check-in system 305 as described in the illustrative embodiments. In this embodiment, a data processing system, such as any of servers 104 and 106, clients 110, 112, or 114, or storage 108 in FIG. 1, may receive a set of parameters about a customer. In one example, the customer is user 314. The set of parameters includes one or more parameters. A parameter is any data that pertains to the customer or a potential user of user check-in system 305, such as user 317, including but not limited to name, age, birthplace, gender, address, phone number, interests, parental/guardian status, or child status. The set of parameters may also include data about communication devices 308 and 311, such as type, model, brand, serial number, or capabilities of the communication device. In one example, the set of parameters may be indicated by input 322. In another example, receiving the set of parameters about the customer(s) includes receiving the set of parameters about the customer(s) from a customer via an Internet website. The set of parameters may also be received via Bluetooth, network 100 in FIG. 1, or communication devices 308 or 311. In another example, the set of parameters about the customer(s) are not sent or inputted by the customer(s) In this example, the set of parameters may be sent or inputted by a person associated with a service provider that services either or both of communication devices 308 and 311, or a person associated with a manufacturer or seller of either or both of communication devices 308 and 311.

A data processing system, such as any of servers 104 and 106, clients 110, 112, or 114, or storage 108 in FIG. 1, may identify a communication device application for use in response to receiving the set of parameters to form an identified communication device application. In one example, the identified communication device application is user check-in system 305, as described in the illustrative embodiments. The identified communication device application may be a Java application.

Upon identifying the identified communication device application, the identified communication device application may then be deployed to either or both of communication device 308 and 311. The identified communication device application may be deployed in a variety of ways. For example, deploying the identified communication device application to either or both of communication device 308 and 311 may include deploying the identified communication device application to either or both of communication device 308 and 311 via Internet, Bluetooth, or Over the Air programming. In another example, the identified communication device application may be deployed at a retail store by an employee of the service provider for either or both of communication device 308 and 311. In this example, a clerk at the retail store may deploy the identified communication device application from a computer at the retail store via a universal serial bus, or USB, connection.

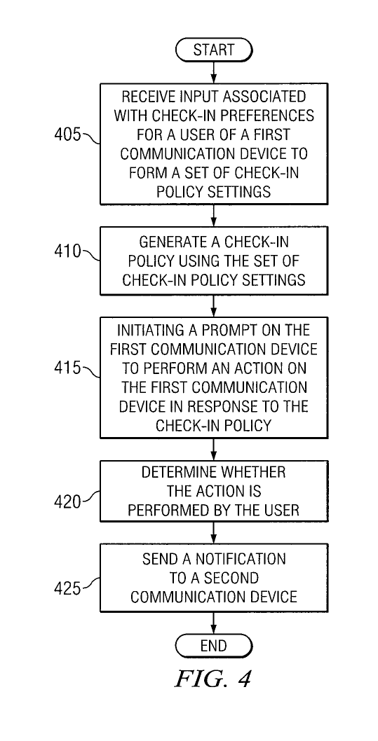

Turning now to FIG. 4, a flowchart illustrating a process for managing messages in a network data processing system is depicted in accordance with an illustrative embodiment. In one embodiment, the process shown in FIG. 4 may be implemented by a user check-in system, such as user check-in system 305 in FIG. 3.

The process begins by receiving input associated with check-in preferences for a user of a first communication device to form a set of check-in policy settings (step 405). The process generates a check-in policy using the set of check-in policy settings (step 410). The process initiates a prompt on the first communication device to perform an action on the first communication device in response to or in accordance with the check-in policy (step 415). The process determines whether the action is performed by the user (step 420). The process sends a notification to a second communication device (step 425).

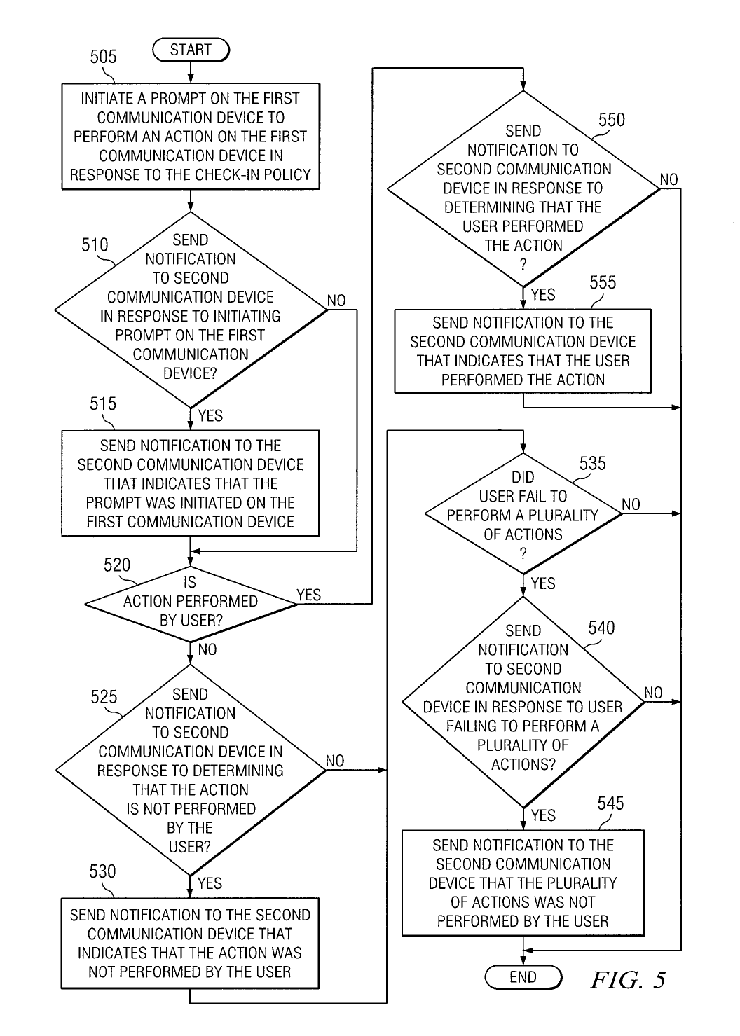

Turning now to FIG. 5, a flowchart illustrating a process for managing messages in a network data processing system is shown in accordance with an illustrative embodiment. In one embodiment, the process shown in FIG. 5 may be implemented by a user check-in system, such as user check-in system 305 in FIG. 3. In one example, the steps shown in FIG. 5 represent additional steps that may be included in steps 415, 420, and 425 in FIG. 4.

The process begins by initiating a prompt on the first communication device to perform an action on the first communication device in response to the check-in policy (step 505). The process determines whether to send a notification to a second communication device in response to initiating a prompt on the first communication device (step 510). If the process determines to send a notification to a second communication device in response to initiating a prompt on the first communication device, the process sends a notification to the second communication device that indicates that the prompt was initiated on the first communication device (step 515). The process then proceeds to step 520.

Returning to step 510, if the process determines not to send a notification to a second communication device in response to initiating a prompt on the first communication device, the process determines whether the action is performed by a user of the first communication device (step 520). If the process determines that the action is not performed by a user of the first communication device, the process determines whether to send a notification to the second communication device in response to determining that the action is not performed by the user of the first communication device (step 525). If the process determines to send a notification to the second communication device in response to determining that the action is not performed by the user of the first communication device, the process sends a notification to the second communication device that the action was not performed by the user (step 530). The process then proceeds to step 535.

Returning to step 525, if the process determines not to send a notification to the second communication device in response to determining that the action is not performed by the user of the first communication device, the process determines whether the user of the first communication device failed to perform a plurality of actions (step 535). If the process determines that the user of the first communication device failed to perform a plurality of actions, the process determines whether to send a notification to the second communication device in response to the user of the first communication device failing to perform the plurality of actions (step 540). If the process determines to send a notification to the second communication device in response to the user of the first communication device failing to perform the plurality of actions, the process sends a notification to the second communication device that the plurality of actions was not performed by the user of the first communication device (step 545). The process then terminates.

Returning to step 540, if the process determines not to send a notification to the second communication device in response to the user of the first communication device failing to perform the plurality of actions, the process then terminates. Returning to step 535, if the process determines that the user of the first communication device did not fail to perform a plurality of actions, the process then terminates.

Returning to step 520, if the process determines that the action is performed by a user of the first communication device, the process determines whether to send a notification to the second communication device in response to determining that the user performed the action (step 550). If the process determines to send a notification to the second communication device in response to determining that the user performed the action, the process sends a notification to the second communication device that indicates that the user of the first communication device performed the action (step 555). The process then terminates. Returning to step 550, if the process determines not to send a notification to the second communication device in response to determining that the user performed the action, the process then terminates.

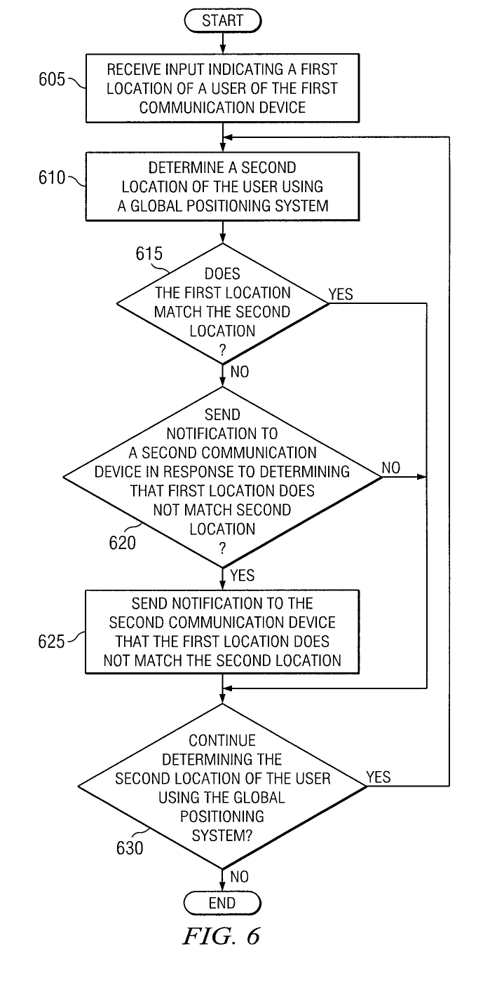

Turning now to FIG. 6, a flowchart illustrating a process for managing messages in a network data processing system in accordance with an illustrative embodiment. In one embodiment, the process shown in FIG. 6 may be implemented by a user check-in system, such as user check-in system 305 in FIG. 3.

The process begins by receiving input indicating a first location of a user of the first communication device (step 605). The process determines a second location of the user of the first communication device using a global positioning system (step 610). The process determines whether the first location matches the second location (step 615). If the process determines that the first location does not match the second location, the process determines whether to send a notification to a second communication device in response to determining that the first location does not match the second location (step 620). If the process determines to send a notification to a second communication device in response to determining that the first location does not match the second location, the process sends a notification to the second communication device that indicates that the first location does not match the second location (step 625). The process then proceeds to step 630.

Returning to step 620, if the process determines not to send a notification to a second communication device in response to determining that the first location does not match the second location, the process proceeds to step 630. Returning to step 615, if the process determines that the first location matches the second location, the process determines whether to continue determining the second location of the user of the first communication device using the global positioning system (step 630). If the process determines not to continue determining the second location of the user of the first communication device using the global positioning system, the process terminates. If the process determines to continue determining the second location of the user of the first communication device using the global positioning system, the process returns to step 610.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

In one non-limiting example, the illustrative embodiments described herein provide an efficient system designed to provide parents and guardians assurance about their children's safety while minimizing interruptions to them. The illustrative embodiments may be particularly beneficial for parents and guardians with several children who are visiting friends, running errands, or performing other activities. The illustrative embodiments may also provide children with a discreet method to check-in with parents, as well as teach and reinforce responsible behavior and minimize interruptions to the children during their social or other activities. Using the illustrative embodiments, the parent or guardian may have a greater “peace of mine” knowing that their child is okay (as a result of the child successfully adhering to the check-in rules of a check-in policy) even though they are not under the parent or guardian's immediate supervision.

The principles of the present invention can take the form of an entirely hardware embodiment, an entirely software embodiment, or an embodiment contacting both hardware and software elements. In one embodiment, the invention is implemented in software, which includes but is not limited to, firmware, resident software, microcode, and other computer readable code.

Furthermore, the principles of the present invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example, without limitation, physical or wireless.

A data processing system suitable for storing and/or executing program code may include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including, but not limited to, keyboards, displays, and pointing devices) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for managing messages in a network data processing system, the method comprising:
receiving input associated with a set of check-in policy settings for a user of a first communication device;
generating a check-in policy using the set of check-in policy settings;
initiating a prompt on the first communication device to perform an action on the first communication device in response to the check-in policy;
determining whether the action is performed by the user; and
sending a notification to a second communication device.

2. The method of claim 1, wherein determining whether the action is performed by the user includes determining that the action is not performed by the user within a predetermined time, and wherein sending the notification to the second communication device includes sending the notification to the second communication device in response to determining that the action is not performed by the user within the predetermined time, the notification indicating that the action was not performed by the user within the predetermined time.

3. The method of claim 1, wherein determining whether the action is performed by the user includes determining whether a plurality of actions is performed by the user, wherein determining whether the plurality of actions is performed by the user includes determining that the plurality of actions is not performed by the user, and wherein sending the notification to the second communication device includes sending the notification to the second communication device in response to determining that the plurality of actions is not performed by the user, the notification indicating that the plurality of actions was not performed by the user.

4. The method of claim 1, wherein determining whether the action is performed by the user includes determining that the action is performed by the user, and wherein sending the notification to the second communication device includes sending the notification to the second communication device in response to determining that the action is performed by the user, the notification indicating that the action was performed by the user.

5. The method of claim 1, wherein sending the notification to the second communication device includes sending the notification to the second communication device in response to initiating the prompt on the first communication device, the notification indicating that the prompt was initiated on the first communication device.

6. The method of claim 1, wherein the set of check-in policy settings indicate at least one of a check-in time period, a check-in frequency, a check-in time, a game mode, a user-phone association, a number of children, a user age, a user level of maturity, a check-in alert type, a notification alert type, a notification mode, and a permission level for the check-in policy.

7. The method of claim 1, wherein the prompt is a first text message, and wherein the notification is a second text message.

8. The method of claim 1, wherein the action is at least one of clicking a button on a graphical user interface of the first communication device, inputting a code, pressing a button on the first communication device, and launching a website via a link.

9. The method of claim 1, wherein determining whether the action is performed by the user includes determining that the action is performed by the user, further comprising:
initiating a game on the first communication device, wherein the game has a goal; and
advancing toward the goal in response determining that the action is performed by the user.

10. The method of claim 1, wherein initiating the prompt on the first communication device initiates an alert on the first communication device, wherein the alert is at least one of a display on a graphical user interface of the first communication device, a sound emitted from the first communication device, a vibration of the first communication device, or a light emitted from the first communication device.

11. The method of claim 1, wherein sending the notification to the second communication device initiates an alert on the second communication device, wherein the alert is at least one of a display on a graphical user interface of the second communication device, a sound emitted from the second communication device, a vibration of the second communication device, or a light emitted from the second communication device.

12. The method of claim 1, wherein the user of the first communication device is a child, and wherein a particular user of the second communication device is at least one of a guardian or a parent of the child.

13. The method of claim 1, wherein the set of check-in policy settings indicate a first location of the user, further comprising:
determining a second location of the user of the first communication device using a global positioning system;
comparing the first location to the second location; and
sending the notification to the second communication device when the first location is different from the second location.

14. The method of claim 1, wherein the input is received from a particular user of the second communication device via a website.

15. The method of claim 1, wherein the first communication device is a first cellular phone, and wherein the second communication device is a second cellular phone.

16. A data processing system comprising:
a bus system;
a memory connected to the bus system, wherein the memory includes a set of instructions; and
a processing unit connected to the bus system, wherein the processing unit executes the set of instructions to: receive data associated with a set of check-in policy settings for a user of a first communication device; generate a check-in policy using the set of check-in policy settings; and
initiate a prompt on the first communication device to perform an action on the first communication device in response to the check-in policy; determine whether the action is performed by the user; and send a notification to a second communication device.

17. The data processing system of claim 16, wherein the processing unit, in determining whether the action is performed by the user, determines that the action is not performed by the user within a predetermined time, and wherein the processing unit, in sending the notification to the second communication device, sends the notification to the second communication device in response to determining that the action is not performed by the user within the predetermined time, the notification indicating that the action was not performed by the user within the predetermined time.

18. The data processing system of claim 16, wherein the first communication device is a first cellular phone, and wherein the second communication device is a second cellular phone.

19. A computer program product comprising:
a computer-usable medium having computer-usable program code for managing messages in a network data processing system, the computer program product comprising:
computer-usable program code for receiving input associated with a set of check-in policy settings for a user of a first communication device;
computer-usable program code for generating a check-in policy using the set of check-in policy settings;
computer-usable program code for initiating a prompt on the first communication device to perform an action on the first communication device in response to the check-in policy;
computer-usable program code for determining whether the action is performed by the user; and
computer-usable program code for sending a notification to a second communication device.

20. The computer program product of claim 19, wherein the first communication device is a first cellular phone, and wherein the second communication device is a second cellular phone.
